(19) United States
(12) Patent Application Publication
(10) Pub. No.: US 2006/0294215 A1
(43) Pub. Date: Dec. 28, 2006

(54) Using a network portal to store diagnostic data

(75) Inventors: Gayle Loretta Noble, Boulder Creek, CA (US); Adam H. Schondelmayer, Cupertino, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Finisar Corporation

(21) Appl. No.: 11/166,713

(22) Filed: Jun. 24, 2005

(51) Int. Cl. G06F 15/173

(52) U.S. Cl. 709/223

(57) ABSTRACT

A data analyzing system. The data analyzing system includes a number of data capture devices. The data capture devices may be for example, at different points in a network or for testing different components in a system. The data analyzing system further includes a distributed storage system connected to the data capture devices. The distributed storage system includes one or more portal servers. The distributed storage system further includes a number of storage servers coupled to the one or more portal servers. The one or more portal servers are configured to direct data from the data capture devices to the storage servers.

### BACKGROUND OF THE INVENTION

1. The Field of the Invention

The invention generally relates to the field of probes and data analyzers. More specifically, the invention relates to storing diagnostic data on a distributed storage system.

2. Description of the Related Art

Modern computer technology has resulted in a world where large amounts of electronic digital data are transferred between various electronic devices or nodes. For example, modem computer networks include computer terminals and nodes that transfer data between one another. Examples of computer networks include small local networks such as home or small office networks to large ubiquitous networks such as the Internet. Networks may be classified, for example, as local area networks (LANs), storage area networks (SANs) and wide area networks (WANs). Home and small office networks are examples of LANs. SANs typically include a number of servers interconnected where each of the servers includes hard-drives or other electronic storage where data may be stored for use by others with access to the SAN. The Internet is one example of a WAN.

Large amounts of data may also be transferred within a computer system between computer components as well. In particular, large amounts of information may be transferred between storage drives, i.e. hard drives, optical drives such as CD and DVD drives, flash memory drives etc, and other components in a computer system.

There is often a need to capture and analyze data traveling on a network or within a computer system. For example, in recent times, networks have come under attack by malicious individuals who desire to steal network data or to disrupt the flow of network data. One type of attack is known as a distributed denial of service (DDoS) attack. A DDoS attack generally involves a number of computers bombarding a network server with requests for data such that the network server is not able to respond to legitimate requests for data. For example, typically, a DDoS attack is initiated by sending a number of servers a request with a mal-formed packet showing a forged initiator of the server they wish to be attacked. The number of servers all send a mal-formed packet error message back to what they think is the originating server bringing the server to be attacked down as it can not answer all of the error messages. This is a tactic meant to disable the server. Each of the requests sent in a particular DDoS attack generally share common characteristics. For example, finding a mal-formed packet error message received from a server that was not sent any packets is a good way to know that a DDOS attack is being triggered. Thus, if the characteristics, such as a mal-formed packet error message from a server that was not sent any packets, can be identified, the server can be instructed to ignore requests that include the characteristics of the requests that are part of the DDoS attack. To identify an attack, a network analyzer may be used to capture data packet. Software can then be used to analyze the data packets.

A network analyzer is a device that captures network traffic and decodes it into a human readable form. Software can then be used to read traces captured by the analyzer. The software is able to recognize abnormalities, patterns, or events such that the network analyzer can begin capturing network data for analysis and storage.

A probe may capture metrics that describe in general parameters what is occurring with the network data. Such metrics may include for example, a measurement of the amount of traffic on a network, where network traffic is coming from or going to, etc. The metrics may be streamed to a storage device. In the DDoS attack scenario, the captured network data or metrics can be analyzed to identify the common characteristic of the requests. Using this information, a DDoS attack can be thwarted by ignoring any requests based on the common characteristics of requests that are part of the DDoS attack. For example, in the case of mal-formed packet errors described above, IP addresses of the servers being used in the attack can be used to drop any packets high up along a routed chain. Additionally, many ISPs can save data packets that can be analyzed to determine where an attack is originally generated.

A network analyzer may also be used in the design process of computer systems. For example, the network analyzer may be used to capture data streams that represent a storage drives reaction to certain commands, requests, or data storage operations. This allows system designers to ensure compatibility between components in a computer system.

One challenge with network analyzers and capturing network data relates to storage of captured network data. Capturing data on one of today's high speed networks involves capturing large amounts of data over a short period of time. This data is typically stored on a storage device such that it can be retrieved an analyzed at a later time.

Further exacerbating the storage problem is when a need arises to probe network data on a network at several different points in the network. When several network analyzer probes are used in a single network, there is often a need or desire to compare the data side by side at the different points to identify troublesome areas in the network. For example, different protocols may be compared or responses of different components may be compared. To compare the data side by side, it is typically desirable to view the data in a single application that is able to display representations of the data in a consolidated fashion. Thus the application should have access to all of the data that is to be represented.

Present solutions, in one example, accomplish this by having a central device with a large amount of storage space being connected to a number of network analyzer probes for receiving the captured network data and metrics. Presently, these solutions may be limited by both the amount of storage that may be implemented and the number of network analyzer probes that may be connected. Computer resources limit the number of network probes that may be connected to a server. Presently, servers may be limited to about sixteen probes. In some present solutions, to compare data traces from different network analyzer probes requires that the data be manually consolidated on a common storage medium or device such that the consolidated data can be accessed by an application that is able to present a side-by-side consolidated view of the data. It would therefore be new and useful to implement storage for data captured by network analyzers that allows for large numbers of probes and large amounts of data that is able to be presented in a consolidated fashion without a manual consolidation of data.

### BRIEF SUMMARY OF THE INVENTION

One embodiment of the invention includes a data analyzing system. The data analyzing system includes a number of data capture devices. The data capture devices may be for example probes, taps or other such devices, at different points in a network or for testing different components in a system. The data analyzing system further includes a distributed storage system connected to the data capture devices. The distributed storage system includes one or more portal servers. The distributed storage system further includes a number of storage servers coupled to the one or more portal servers. The one or more portal servers are configured to direct data from the data capture devices to the storage servers.

Another embodiment of the invention includes a method of storing analysis data. The method includes generating data at a number of data capture points. The method further includes sending the data generated at the probes to a distributed storage system. The data generated at the probes is stored in a plurality of storage servers. The data generated at the probes and stored in the storage servers is indexed in one or more portal servers.

One embodiment includes computer-readable media for carrying or having computer-executable instructions. The computer-executable instruction direct receiving data from a number of probes. The instructions further direct storing the data in a number of storage servers in a distributed fashion and indexing the stored data in a portal server or group of servers.

Advantageously, embodiments described above allow for data from probes to be stored in a distributed system. By using a centralized portal server or index, data that is stored in separate storage servers can be combined to generate a blended trace representing data characteristics. This allows for a comparison of data even when that data is generated in different parts of a network or by different components. Additionally, by allowing data from the probes to be stored in a distributed environment, the system has virtually unlimited scalability. By allowing data to be stored on any one of a number of storage servers, enough processing power, network bandwidth, and storage space can be added to a system to allow for capturing or generating data at a number probes greater than what has previously been available.

These and other advantages and features of the present invention will become more fully apparent from the following description and appended claims, or may be learned by the practice of the invention as set forth hereinafter.

### BRIEF DESCRIPTION OF THE SEVERAL VIEWS OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a functional block diagram showing one method for transaction level monitoring of a high speed communications network, such as a storage area network (SAN);

FIG. 2 illustrates a block diagram of a network monitoring device, or “probe,” that can be used in conjunction with the method of transaction monitoring of FIG. 1;

FIG. 3 is a flow chart illustrating one example of a series of computer executable steps that can be used to control the operation of a network monitoring device, such as the probe illustrated in FIG. 2; and

FIGS. 4A-10 illustrate additional various examples of embodiments of user interfaces provided at a client tier of a exemplary monitoring system.

### DETAILED DESCRIPTION OF THE INVENTION

Some embodiments set forth herein make use of a distributed storage environment including one or more centralized servers that functions as a portal for one or more network capture devices, such as probes, taps, network analyzers, etc. The one or more centralized servers are connected to a number of storage servers. The one or more centralized servers direct captured data and/or metrics to an appropriate storage server. The one or more centralized servers may direct captured data or metrics to storage servers based on various criteria. For example, the one or more centralized servers may direct captured data or metrics to a storage server based on a round-robin scheme. This allows capturing and storage operations to be shared equally, or substantially equally, or according to a storage servers capabilities among the various storage servers. In an alternative embodiment, the one or more centralized servers may direct captured data or metrics to storage servers based on packet type. This allows each storage server to be optimized for a particular type of data. This type of storage scheme may sort packets for example, by protocol type. In yet another embodiment, the one or more centralized servers may direct captured data or metrics to storage servers based on priority. Network packets are typically labeled with a priority so as to allow higher rated priority packets to be routed more quickly on a network. The one or more centralized servers may direct data packets to a storage server depending on the priority level specified in the data packet.

The monitoring tools described herein may incorporate various features of network and computing environment monitoring systems such as those described in U.S. patent application Ser. No. 10/424,367 filed Apr. 25, 2003 and entitled “A System And Method For Providing Data From Multiple Heterogeneous Network Monitoring Probes To A Distributed Network Monitoring System” which is incorporated herein by reference in its entirety.

While the following description is generally directed to a network environment, embodiments of the invention may be used for other types of data monitoring as well. For example, embodiments may be used to monitor data traffic between components in a computer system. One exemplary embodiment is useful for monitoring storage drive response when a particular command or instruction or set of data is supplied to a storage drive. In fact, embodiments of the invention may be directed to any number of different metrics that are being collected. This system could store information on stock prices or the local temperature as long as there is a probe or other capture device to provide the data.

### THE OVERALL MONITORING SYSTEM

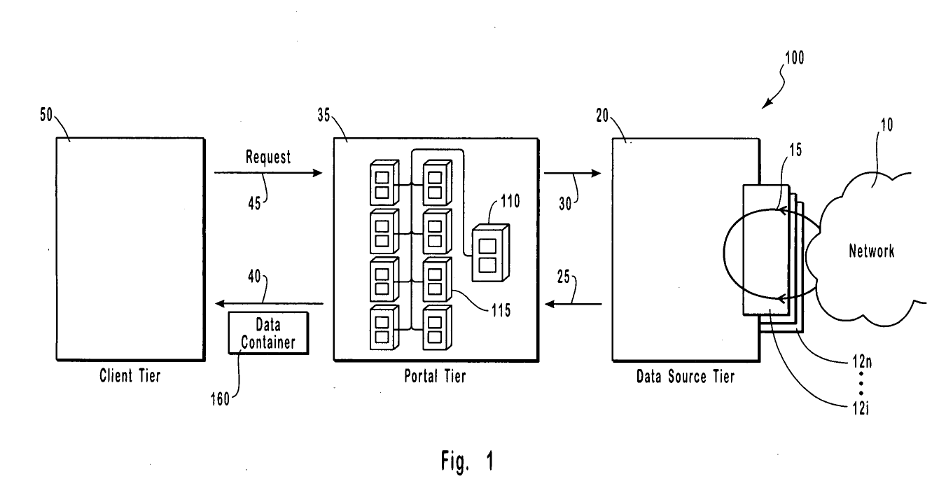

In general, one embodiment of the overall monitoring system is implemented with three distinct tiers of functional components within a distributed computing and networking system. These three tiers of the monitoring system, which is designated generally at 100 in FIG. 1, are referred to herein as a data source tier 20, a portal tier 35 and a client tier 50. The data source tier 20 is preferably comprised of multiple sources for data traffic measurements at various points within a network, shown as 10 in FIG. 1 or within a computer system. The portal tier 35 is a middle tier within the hierarchy, and generally provides the function of collection, management and reformatting of the data collected at the data source tier 20 as well as management of the entities that perform the role of the data source tier. Finally, the top level tier—referred to as the client tier 50—is preferably comprised of software implemented clients that provide visualizations of the network traffic monitored at the data source tier 20. Optionally, the client tier 50 also provides additional ancillary processing of the monitored data. While the embodiment described above makes reference to capturing data on a network, it should be understood that embodiments may also be used for monitoring general computer systems such as for monitoring storage device performance or other data handling performance.

Following is a more detailed description of one implementation of the three tiers used in the current monitoring system 100.

### THE DATA SOURCE TIER

The data source tier 20 is comprised of one or more sources, i.e. data capture devices, for network traffic measurements that are collected at one or more data capture points in the network topology, designated at 10. The data source tier 20 monitors network traffic traversing each network data capture point being monitored. The data source tier 20 may produce a numeric descriptive summary (referred to herein as a “metric”) for all of the network traffic within a particular monitoring interval when the data capture device is a probe. Alternatively, the data source tier 20 may capture specific packets of data such as when a network analyzer or tap is used as a data capture device. Thus, as used herein, generating data at a data capture point includes generating metrics and capturing network data. As is indicated at schematic line 25, each metric or data packet is then passed to the next tier in the overall system 100, the portal tier 35, which is described below. In the example embodiment descriptive metrics are “storage I/O” centric; that is, they contain attributes of multi-interval storage I/O transactions between devices, as well as instantaneous events. Storage I/O transaction metrics can include, for example, attributes such as latency for transactions directed to a particular storage device; response times for a particular device; block transfer sizes; completion status of a transfer; and others. Instantaneous event attributes can include, for example, certain types of errors and non-transaction related information such as aggregate throughput (e.g., megabytes/second).

The multiple sources used to measure network traffic in FIG. 1 are probes, designated at 12 in FIG. 1. While probes are illustrated here, other capture devices may also be used such as taps and/or network analyzers. As noted, these probes 12 are inserted into the network 10 at different locations to produce specific information about the particular data flow, one example of which is represented at 15, at the given network connection point. Again, attributes of the monitored data can be identified and placed in the form of a metric by the probe 12. Alternatively, specific data packets, or portions of data packets can be captured. Thus, each probe 12 is implemented to generate metrics that characterize and/or represent the instantaneous events and storage I/O transactions that are monitored. Often, and depending on the type of attribute involved, multiple storage I/O transactions are observed and analyzed before a particular metric can be constructed.

The probes 12 are preferably implemented so as to be capable of monitoring the network data flow 15 and generating the corresponding metric(s) in substantially real time. Said differently, the probes are able to continuously generate metrics about the traffic as fast as the traffic occurs within the network 10, even at Gigabit traffic rates and greater. In the exemplary embodiment, the network 10 is implemented as a high speed SAN that is operating in excess of one Gigabit per second.

In an alternative embodiment, a passive optical tap can be disposed between the network medium and the probe device. The passive tap is then used to feed a copy of the data flow 15 directly into the probe. One advantage of incorporating a passive optical tap is that if the probe malfunctions for any reason, the data flow 15 within the network 10 is not affected. In contrast, if a probe is used directly “in-line,” there is a potential for data interruption if the probes malfunctions. Also, when connected via a passive tap, the probes do not become identified devices within the network 10, but are merely inserted to calculate and measure metrics about the data flow 15 wherever they are located.

It will be appreciated that a number of probe 12 implementations could be used. However, in general, the probe 12 provides several general functions. First, each probe 12 includes a means for optically (if applicable), electrically and physically interfacing with the corresponding network 10, so as to be capable of receiving a corresponding data flow. In addition, each probe 12 includes a high speed network processing circuit that is capable of receiving a data flow 15 from the network and then processing the data flow 15 so as to generate a corresponding metric or metrics. In particular, the high speed processing circuit must be able to provide such functionality in substantially real time with the corresponding network speed. The probe 12 may further include a separate programmable device, such as a microprocessor, that provides, for example, the functional interface between the high speed processing circuit and the portal tier 35. The programmable device would, for example, handle the forwarding of the metric(s) or captured data at the request of the portal tier 35. It may also format the metrics or captured data in a predefined manner, and include additional information regarding the probe 12 for further processing by the portal tier 35. It will be appreciated that the above functionality of the high speed processing circuit and the separate programmable device could also be provided by a single programmable device, provided that the device can provide the functionality at the speeds required.

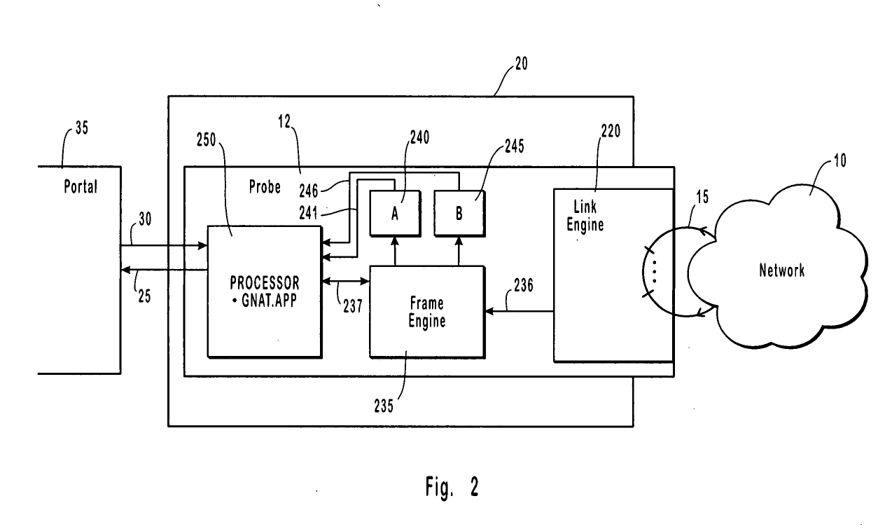

By way of example and not limitation, one presently preferred probe implementation is shown in FIG. 2, to which reference is now made. The probe 12 generally includes a link engine circuit, designated at 220, that is interconnected with a high speed, network traffic processor circuit, or “frame engine” 235. In general, the frame engine 235 is configured to be capable of monitoring intervals of data 15 on the network, and then processing and generating metric(s) containing attributes of the monitored data. While other implementations could be used, in a presently preferred embodiment, this frame engine 235 is implemented in accordance with the teachings disclosed in U.S. Pat. No. 6,880,070, issued Apr. 12, 2005, entitled “Synchronous Network Traffic Processor” and assigned to the same entity as the present application. That Patent is incorporated herein by reference in its entirety.

Also included in probe 12 is programmable processor, such as an embedded processor 250, which has a corresponding software storage area and related memory. The processor 250 may be comprised of a single board computer with an embedded operating system, as well as hardware embedded processing logic to provide various functions. Also, associated with processor 250 is appropriate interface circuitry (not shown) and software for providing a control interface (at 237) and data interfaces (at 241 and 246) with the frame engine 235, as well as a data and control interface with the portal tier 35 (at 30 and 25). In a preferred embodiment, the processor 250 executes application software for providing, among other functions, the interface functionality with the frame engine 235, as well as with the portal tier 35. One presently preferred implementation of this embedded application software is referred to herein, and represented in FIG. 2, as the “GNAT.APP.”

The link engine 220 portion of the probe 12 preferably provides several functions. First, it includes a network interface portion that provides an interface with the corresponding network 10 so as to permit receipt of the interval data 15. In addition, the link engine 220 receives the data stream interval 15 and restructures the data into a format more easily read by the frame engine logic 235 portion of the probe 12. For example, the link engine 220 drops redundant or useless network information present within the data interval and that is not needed by the frame engine to generate metrics. This insures maximum processing efficiency by the probe 12 circuitry and especially the frame engine circuit 235. In addition, the link engine can be configured to provide additional “physical layer”-type functions. For example, it can inform the frame engine when a “link-level” event has occurred. This would include, for example, an occurrence on the network that is not contained within actual network traffic. For example, if a laser fails and stops transmitting a light signal on the network, i.e., a “Loss of Signal” event, there is no network traffic, which could not be detected by the frame engine. However, the condition can be detected by the link engine, and communicated to the frame engine.

The data flow interval obtained by the link engine is then forwarded to the frame engine 235 in substantially real time as is schematically indicated at 236. The interval data is then further analyzed by the frame engine 235, which creates at least one descriptive metric. Alternatively, multiple data intervals are used to generate a metric, depending on the particular attribute(s) involved.

As noted, one primary function of the probe is to monitor the interval data 15, and generate corresponding metric data in substantially real time, i.e., at substantially the same speed as the network data is occurring on the network 10. Thus, there may be additional functionality provided to increase the overall data throughput of the probe. For example, in the illustrated embodiment, there is associated with the frame engine logic 235 a first data storage bank A 240 and a second data storage bank B 245, which each provide high speed memory storage buffers. In general, the buffers are used as a means for storing, and then forwarding—at high speeds—metrics generated by the frame engine. For example, in operation the frame engine 235 receives the monitored intervals of network data from the Link Engine 220, and creates at least one metric that includes attribute characteristics of the intervals of data. However, instead of forwarding the created metric(s) directly to the portal tier 35, it is first buffered in one of the data banks A 240 or B 245. To increase the overall throughput, while one data bank outputs its metric contents to the processor 250 (e.g., via interface 241 or 246), the other data bank is being filled with a new set of metric data created by the frame engine 235. This process occurs in predetermined fixed time intervals; for example, in one preferred embodiment the interval is fixed at one second.

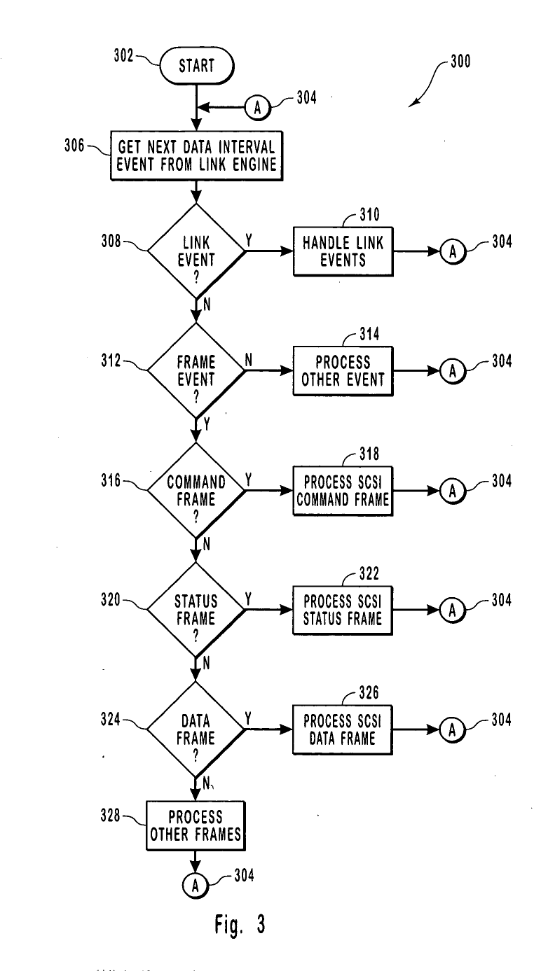

Reference is next made to FIG. 3, which illustrates a flow chart denoting one example of a methodology, preferably implemented by way of computer executable instructions carried out by the probe's programmable devices, for monitoring network data and deriving metrics therefrom. This particular example is shown in the context of a Fibre Channel network running a SCSI upper level protocol. It will be appreciated however that the embodiment of FIG. 3 is offered by way of example and should not be viewed as limiting the present scope of the invention. Indeed, specific steps may depend on the needs of the particular implementation, the network monitoring requirements, particular protocols being monitored, etc.

Thus, beginning at step 302, a series of initialization steps occurs. For example, the overall probe system is initialized, various memory and registers are cleared or otherwise initialized. In a preferred embodiment, an “exchange table” memory area is cleared. The exchange table is an internal structure that refers to a series of exchange blocks that are used to keep track of, for example, a Fibre Channel exchange (a series of related events). In particular, ITL (Initiator/Target/Lun) exchange statistics (metrics) are generated using the data from this table. Data included within the exchange table may include, for example, target ID, initiator ID, LUN and other information to identify the exchange taking place. Additional data would be used to track, for example, payload bytes transmitted, the time of the command, the location where the data for the ITL is stored for subsequent transmission to the portal tier, and any other information relevant to a particular metric to be generated. Thus, in the present example, when a command is received, the table is created. The first data frame time is recorded, and the number of bytes is added whenever a frame is received. Finally, the status frame is the last event which completes the exchange and updates the table.

Once the requisite initialization has occurred, processing enters an overall loop, where data intervals on the network are monitored. Thus, beginning at program step 306, the next data interval “event” is obtained from the network via the link engine. Once obtained, processing will proceed depending on the type of event the data interval corresponds to.

If at step 308 it is determined that the data interval event corresponds to a “link event,” then processing proceeds at step 310. For example, if the link engine detects a “Loss of Signal” event, or similar link level event, that condition is communicated to the frame engine because there is no network traffic present. Processing would then continue at 304 for retrieval of the next data interval event.

If at step 312 it is determined that the data interval event corresponds to an actual network “frame event,” then processing proceeds with the series of steps beginning at 316 to first determine what type of frame event has occurred, and then to process the particular frame type accordingly. In the illustrated example, there are three general types of frame types: a command frame; a status frame; and a data frame. Each of these frames contains information that is relevant to the formulation of metric(s). For example, if it is determined that there is a command frame, then processing proceeds at 318, and the SCSI command frame is processed. At that step, various channel command statistics are updated, and data and statistics contained within the exchange table is updated. This information would then be used in the construction of the corresponding metric.

If however, the event corresponds to a status frame at step 320, then processing proceeds with a series of steps corresponding to the processing of a SCSI status frame at step 322. Again, corresponding values and statistics within the exchange table would be updated. Similarly, if the event corresponds to a SCSI data frame, processing proceeds at step 326, where a similar series of steps for updating the exchange table. Note that once a frame event has been identified and appropriately processed, processing returns to step 306 and the next data interval event is obtained.

Of course, implementations may also monitor other frame types. Thus, if the event obtained at step 306 is not a link event, and is not a SCSI frame event, then processing can proceed at step 328 with other frame event types. Processing will then return at step 306 until the monitoring session is complete.

It will be appreciated that FIG. 3 is meant to illustrate only one presently preferred operational mode for the probe, and is not meant to be limiting of the present invention. Other program implementations and operation sequences could also be implemented.

### THE PORTAL TIER

From a functional standpoint, the portal tier 35 gathers the metrics and data generated at the data source tier 20, and manages and stores the metrics and data for later retrieval by the upper client tier 50, which is described below. During operation, the portal tier 35 forwards a data request, as indicated at 30 in FIG. 1, to a particular data source tier 20 via a predefined data interface. The data source tier 20 responds by forwarding metric(s) and/or captured data, as is indicated at 25, to the portal tier 35. Data may be transferred between the portal tier 35 and the data source tier 20 via various mediums including wirelessly or through standard network cables.

Once the portal tier 35 has requested and received metrics and/or captured data from a corresponding data source tier 20, the portal 35 then organizes the metrics and/or captured data in a predefined manner for either storage, reformatting, and/or immediate delivery to the client tier 50 as “secondary data.” Note that the metrics and/or captured data can be stored or otherwise manipulated and formatted into secondary data at the portal tier 35 in any one of a number of ways, depending on the requirements of the particular network monitoring system. For example, if each of the data probes 12i-12n within a given monitoring system provides metrics that have an identical and consistent format, then the metrics could conceivably be passed as secondary data directly to the client tier 50 without any need for reformatting. However, in one embodiment, the metric data received from data tier(s) is transformed into secondary data that is encapsulated into a predefined format before it is provided to the client tier 50. In this particular embodiment, the format of the data forwarded to the client tier 50 is in the form of a “data container,” designated at 160 in FIG. 1.

Thus, in the illustrated example, data probes within the data source tier passively monitor traffic within the network (such as link traffic in a SAN). The portal tier then actively “collects” information from the probes, and then provides the client tier with a programmatic interface to integrated views of network activity via the data container.

In the example shown, the portal tier is implemented using a centralized portal server 110 and a number of storage servers 115. The centralized portal server 110 may be, for example, a SharePoint 2003 server available from Microsoft Corporation in Redmond, Wash. The centralized portal server 110 is configured to direct metrics and/or captured network traffic to the storage servers 115 for storage.

In one embodiment, the centralized portal server 110 includes functionality for discovering data capture devices, such as the probes 112, on a network or in a computer system. The centralized portal server 110 further includes information about each of the storage servers. Such information may include information such as physical location, resources, type of data packets to be stored at the storage severs 115 and the like. The centralized portal server 110 can direct the probes 112 to send data to a particular storage server 115 based on the information about the storage servers 115. For example, the centralized portal server 110 may direct a particular probe 112 to send captured data or metrics to a storage server 115 that is in close proximity to the probe 112. This allows the probe 112 to send data on a channel that may have a higher bandwidth than if the probe 112 were to be required to send captured data or metrics to a more remotely located server.

The storage servers 115 may be located in various locations. In other words, the storage servers 115 do not necessarily need to be located in the same physical location. Storage servers may be located in different rooms, different buildings, different cities, etc.

In other embodiments, the centralized portal server 110 can direct data to be sent to storage servers 115 based on any number of criteria including those mentioned above of packet type, priority, storage server resources and the like. The centralized portal server 110 maintains an index of the information stored in the storage servers 115 for quick and efficient retrieval of the data for later viewing or analysis. Notably, in one embodiment, captured data and metrics do not themselves necessarily pass through the centralized portal server 110, but rather are directed to a particular storage server 115. For example, the probe 112 may contact the centralized portal server 110 by using the portal server's network address. The probe 112 requests an address from the centralized portal server 110 for a storage server address. The request may include information about the probe 112, such as location, network connection type, etc, and/or information about the data to be stored, such as protocol, priority and the like. The centralized portal server 110 provides a storage server address to the probe 112 in response to the request. The address provided to the probe may be chosen by the centralized portal server 110 based on the information in the request from the probe 112. The probe 112 then sends captured data or metrics to the storage server for storage.

Additionally, a number of portal servers may be used in place of the single centralized portal server 110 illustrated above. Specifically, the centralized portal server 110 may include an index that indexes the location of captured data on the various storage servers 115. Such an index may be distributed across a number of portal servers such that one or more portal servers may be used to direct data generated at data capture points by data capture devices. In one embodiment, the portal servers may be included on one or more of the storage servers 115. Alternatively, the portal servers may be implemented on one or more of the data capture devices if a data capture device includes appropriate hardware, such as an integrated hard drive, to support server software on the data capture device. Thus, when a centralized portal server is recited herein, that server may be logically centralized and is not required to be physically centralized in a given location.

The centralized portal server 110 can direct metrics and captured network traffic based on various criteria. For example, the centralized portal server 110 can direct data based on a round robin scheme, a packet type scheme, a priority scheme, or any other appropriate scheme.

In a round robin scheme, capturing and storage operations can be shared equally, or substantially equally, or according to a storage servers capabilities among the various storage servers 115.

In an alternative embodiment, the centralized portal server 110 may direct captured data or metrics to storage servers 115 based on packet type. This allows each storage server 115 to be optimized for a particular type of data. This type of storage scheme may sort packets for example, by protocol type.

In yet another embodiment, the centralized portal server 110 may direct captured data or metrics to storage servers based on priority. Network packets are typically labeled with a priority so as to allow higher rated priority packets to be routed more quickly on a network. The centralized portal server 110 may direct data packets to a storage server depending on the priority level specified in the data packet.

In still another embodiment, the centralized portal server 110 may direct data packets to a storage server based on location. In particular, the centralized portal server 110 may direct data packets to a storage server that is in relatively close proximity to the probe 112 where the data is generated. This allows for higher bandwidth channels to be used to transfer data for storage.

The portal tier 35 appears to the client tier 50 to be a single consolidated database. However, the client tier 35 may be a distributed database with data stored on a number of storage servers 115. The centralized portal server 110 maintains an index of what is stored on the storage servers 115 so as to be able to quickly access any data requested by the client tier 50. The centralized portal server 110 may store and retrieve data, in one embodiment, by employing database structures and commands such as those used in MySQL available from MySQL AB in Uppsala Sweden.

The storage server may include software that receives data from data capture devices, such as the probes, and puts that data into a database, filesystem, or other storage structure. This way the data can be encoded and/or compressed so less bandwidth is required between the data capture device and the storage server. Because the data capture devices can be physically distant from the storage server, bandwidth preservation is important.

### THE CLIENT TIER

In general, the client tier, designated at 50 in FIG. 1, is comprised of software components executing on a host device that initiates requests for the secondary data from the portal tier 35. One example of the type of software components includes NetWisdom available from Finisar Corporation in Sunnyvale, Calif. Preferably, the client tier 50 requests information 45 from the portal tier 35 via a defined data communication interface, as is indicated schematically at 45 in FIG. 1. In response, the portal tier 35 provides the secondary data to the client tier 50, as is schematically indicated at 40, also via a defined interface.

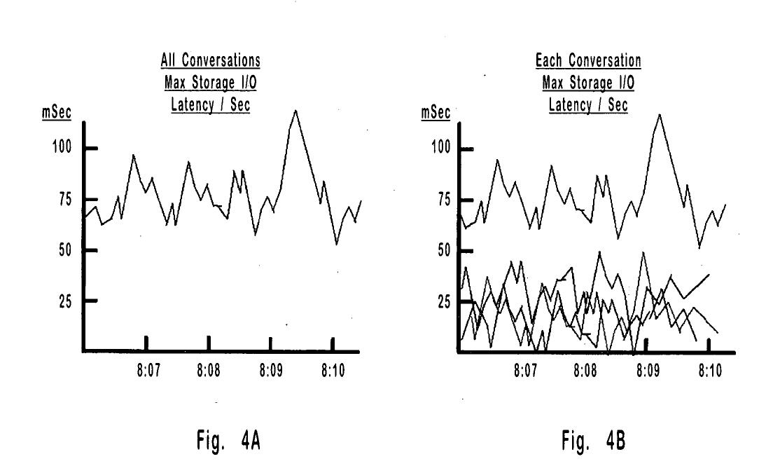

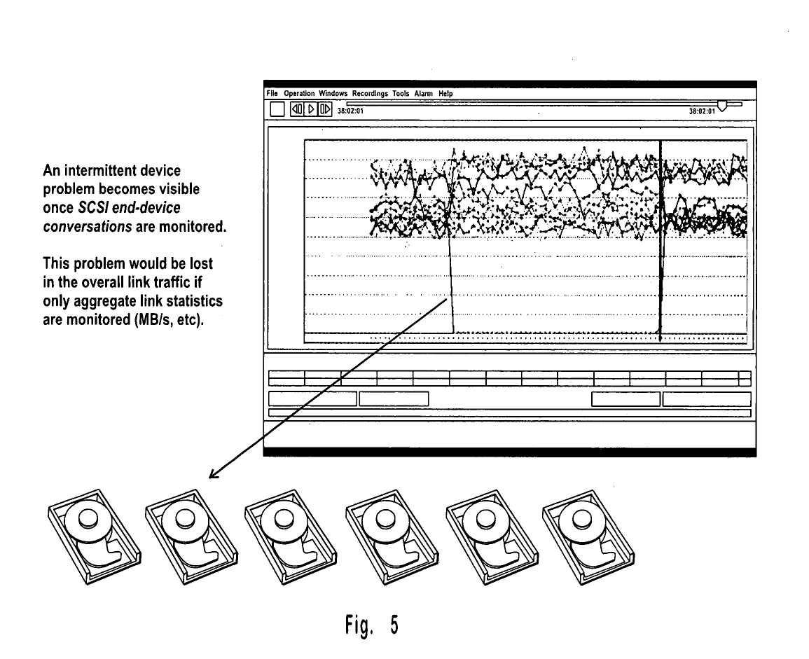

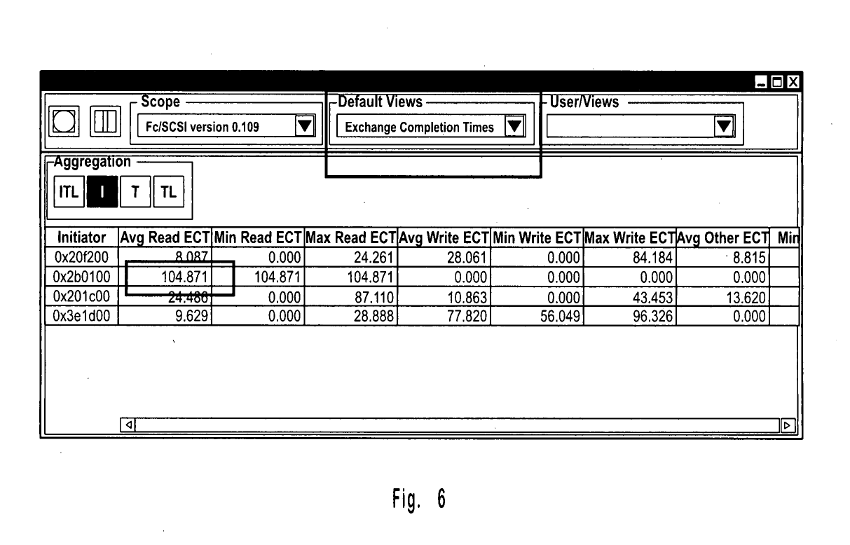

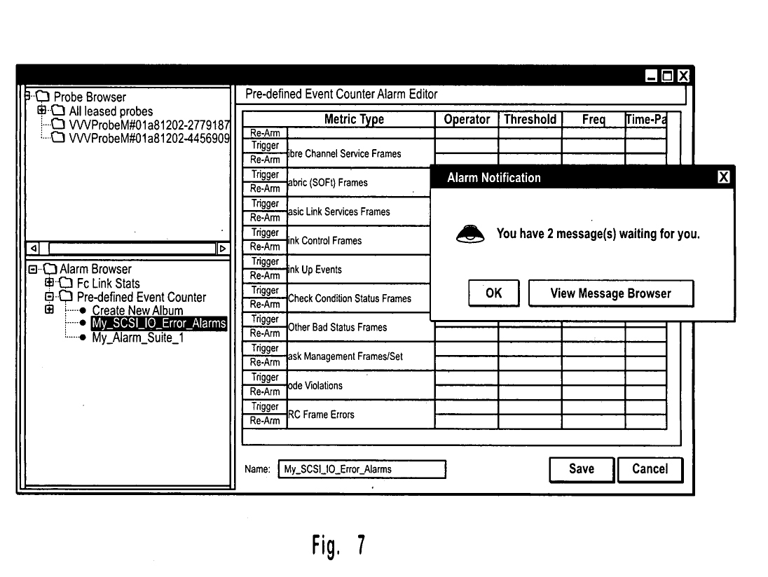

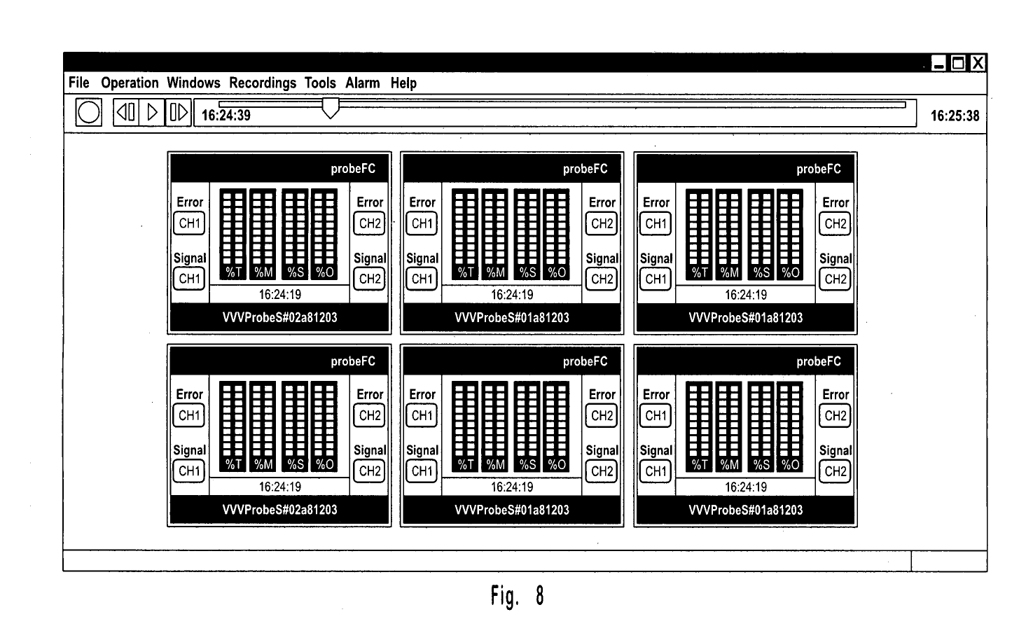

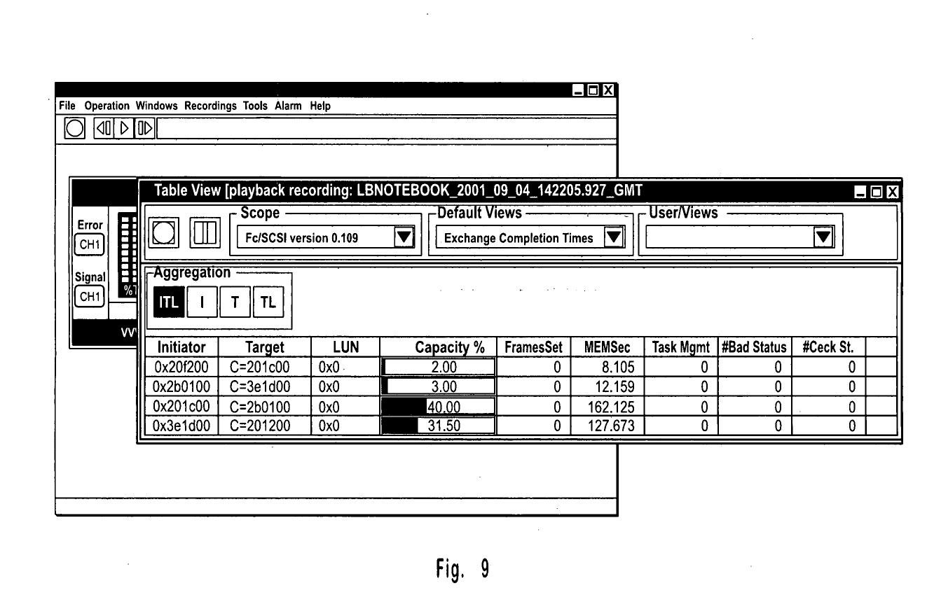

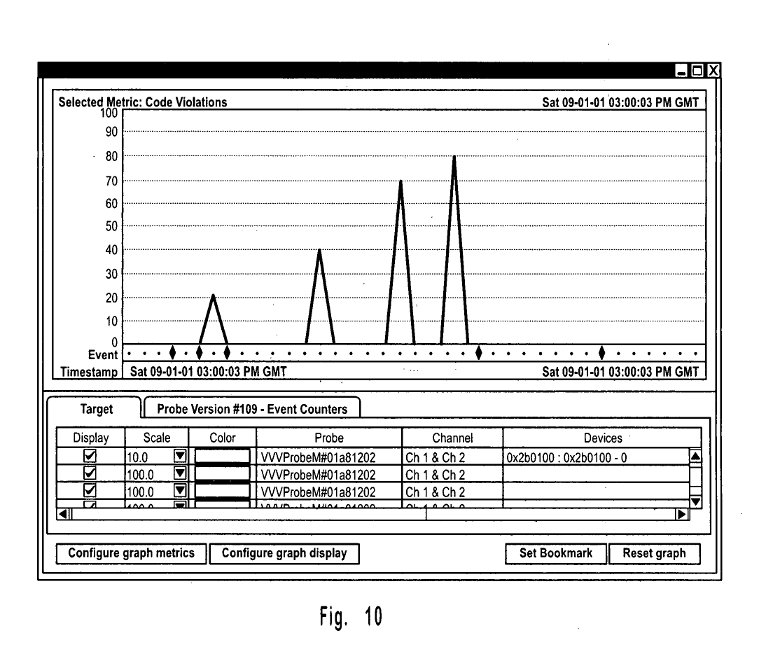

Once secondary data is received, the client tier 50 presents the corresponding information via a suitable interface to human administrators of the network. Preferably, the data is presented in a manner so as to allow the network administrator to easily monitor various transaction specific attributes, as well as instantaneous event attributes, detected within the SAN network at the various monitoring points. By way of example, FIGS. 4A-10 illustrate some examples of some of the types of data and network information that can be presented to a user for conveying the results of the transaction monitoring. For example, FIGS. 4A, 4B and 5 illustrate a graphical interface showing end-device conversation monitoring using what is referred to as a Client Graph Window. FIG. 6 illustrates a graphical user interface showing real time transaction latency attributes for a particular storage end-device. FIG. 7 is an illustration of an Alarm Configuration window and an Alarm Notification pop-up window, which can be used to alert a user of the occurrence of a pre-defined network condition, for example. FIG. 8 is an illustration of a “Fabric View” window that provides a consolidated view of traffic levels at multiple links within the network. FIG. 9 is an illustration of “instantaneous” attributes of network traffic, per “end-device” conversation within a single monitored link. FIG. 10 is an illustration of a trend analysis of a single traffic attribute over time. It will be appreciated that any one of a number of attributes can be displayed, depending on the needs of the network manager.

In addition to displaying information gleaned from the secondary data, the client tier 50 can also provide additional ancillary functions that assist a network administer in the monitoring of a network. For example, in one embodiment, the client tier 50 can be implemented to monitor specific metric values and to then trigger alarms when certain values occur. Alternatively, the monitoring and triggering of alarms can occur in the Portal tier 35, and when the alarm condition occurs, the portal tier 35 sends a notification message to the client tier 50, which is illustrated in FIG. 11. Another option is to log a message to a history log (on the Portal), and the alarm history log can then be queried using the Client interface. Yet another option is for the occurrence of an alarm condition to trigger a recording of all network metrics for a predetermined amount of time. For example, it may be necessary for a network administrator to closely monitor the response time of a data storage device. If the data storage device's response time doubles, for example, an alarm can be configured to alert the network administrator and trigger a metric recording for analysis at a later time. Any one of a number of other alarm “conditions” could be implemented, thereby providing timely notification of network problems and/or conditions to the network administrator via the client tier 50 or email notification.

Separate portal tiers 35 can be located in different geographical locations, and interconnected with a single client tier 50 by way of a suitable communications channel. This would allow one client tier to monitor multiple SAN networks by simply disconnecting from one portal tier and connecting to another portal tier. This communications interface could even be placed on the Internet to facilitate simplified monitoring connections from anywhere in the world. Similarly, a Web (HTTP) interface can be provided to the Portal. In another embodiment, by implementing a portal tier 35 that includes a centralized portal server 110 and a number of storage servers 115, a single client tier 50 can monitor multiple SAN, other networks and/or computer systems simultaneously without the need to disconnect as probes 15 located in various locations can transmit data to storage servers 115 in various locations, that are all interconnected via the central server 110.

In yet another embodiment, the client tier 50 could be replaced by an application programming interface (API) such that third-party vendors could produce a suitable user interface to display various transaction specific attributes, as well as instantaneous event attributes, received via the secondary data. Any appropriate interface could be utilized, including a graphics-based or a text-based interface.

It may be advantageous to view blended data at the client tier 50. Blended data may include data from a number of different sources such as from different probes 12 in a network. Thus, in one embodiment, blended data may be displayed at the client tier 50 where the blended data is presented in a way such that data from different probes at different points in a network or connected to different devices can be compared.

Blended data may allow for the client tier to display, in a consolidated format, data from different components. For example, it may be desirable to display responses of different manufacturers and/or models of storage devices, such as hard drives. Alternatively, a single storage device's responses at different times can be viewed to diagnose problems with the storage device.

Data is received by the client tier 50 from the portal tier 35. While portal tier 35 appears to the client tier 50 as a single consolidated database, the portal tier 35 may in fact be a distributed database with data stored in a variety of locations.

The present invention also may be described in terms of methods comprising functional steps and/or non-functional acts. Usually, functional steps describe the invention in terms of results that are accomplished, whereas non-functional acts describe more specific actions for achieving a particular result. Although the functional steps and non-functional acts may be described or claimed in a particular order, the present invention is not necessarily limited to any particular ordering or combination of acts and/or steps.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disc storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A data analyzing system comprising:
a plurality of data capture devices;
a distributed storage system coupled to the plurality of data capture devices wherein the distributed storage system comprises:
one or more portal servers; and
a plurality of storage servers coupled to the one or more portal servers, wherein the one or more portal servers are configured to direct data from the plurality of data capture devices to the plurality of storage servers.

2. The data analyzing system of claim 1, wherein at least a portion of the plurality of data capture devices are coupled to data storage devices to monitor the performance of the data storage devices.

3. The data analyzing system of claim 1, wherein at least a portion of the plurality of data capture devices are coupled to network devices to monitor the performance of the network devices.

4. The data analyzing system of claim 1, wherein the one or more portal servers direct data to the plurality of storage servers using a round robin scheme.

5. The data analyzing system of claim 1, wherein the one or more portal servers direct data to the plurality of storage servers using a priority scheme.

6. The data analyzing system of claim 1, wherein the one or more portal servers direct data to the plurality of storage servers using a packet type and/or protocol scheme.

7. The data analyzing system of claim 1, wherein at least one of the storage servers is located in a different physical location than one of the data capture devices, one of the one or more portal servers, and one of the plurality of storage servers.

8. The data analyzing system of claim 1, wherein the data capture device is a probe.

9. The data analyzing system of claim 1, wherein the data capture device is a tap or network analyzer.

10. A method of storing analysis data, the method comprising:
generating data at a plurality of data capture points;
sending the data generated at the plurality of data capture points to a distributed storage system;
storing the data generated at the plurality of data capture points in a plurality of storage servers; and
indexing the data generated at the plurality of probes and stored in the plurality of storage servers in one or more portal servers.

11. The method of claim 10 wherein the act of storing comprises sending data to the storage servers using a round robin scheme.

12. The method of claim 10 wherein the act of storing comprises sending data to the storage servers using a priority scheme.

13. The method of claim 10 wherein the act of storing comprises sending data to the storage servers using a protocol scheme.

14. The method of claim 10, further comprising displaying a representation of at least a portion of the data.

15. The method of claim 14, wherein displaying a representation of the least a portion of the data comprises displaying blended data.

16. The method of claim 15, wherein displaying blended data comprises displaying data generated at data capture devices at data capture points in a network.

17. The method of claim 15, wherein displaying blended data comprises displaying the response of components measured at different times.

18. The method of claim 15, wherein displaying blended data comprises displaying the response of different components to the same or similar commands.

19. The method of claim 10 wherein the act of generating data at a plurality of data capture devices comprises capturing data.

20. The method of claim 10 wherein the act of generating data at a plurality of data capturing devices comprises generating metrics.

21. Computer-readable media for carrying or having computer-executable instructions for performing the following act:
receiving data from a plurality of data capture devices;
storing the data in a plurality of storage servers in a distributed fashion; and
indexing the store data in a portal server.
